(19) United States
(12) Patent Application Publication
(10) Pub. No.: US 2016/0034153 A1
(43) Pub. Date: Feb. 4, 2016

(54) Icon Resizing

(71) Applicant: Microsoft Corporation, Redmond, WA (US)

(72) Inventors: Christophe D. Lejeune, Seattle, WA (US); Andres Antonio Toussaint, Sammamish, WA (US)

(21) Appl. No.: 14/448,586

(22) Filed: Jul. 31, 2014

(51) Int. Cl. G06F 3/0484; G06F 3/0486; G06T 13/80; G06F 3/0481

(52) U.S. Cl. CPC G06F 3/04847; G06F 3/04817; G06F 3/0486; G06T 13/80

(57) ABSTRACT

Icon resizing techniques are described herein in which enable resizing of icons for a user interface to select between multiple available sizes may occur intuitively by using input or gestures applied to the icon to visually move the icon boundaries to a desired size. In operation, initiation of a resize operation to modify boundaries of an icon within a user interface is detected. A comparison of the modified boundaries to available sizes supported by the user interface is made. Then, one of the available sizes is selected based on similarity to the modified boundaries and the icon is resized to the selected size. In one approach, resizing is accomplished by a drag and snap operation in which boundaries of an icon are dragged and then released at a desired size, at which point the icon snaps to the closest one of the pre-defined sizes.

### BACKGROUND

User interfaces for computing devices including mobile devices have evolved to simplify navigation of and interaction with settings, applications, files and other content items associated with the devices. For instance, in order to provide an efficient and easy-to-use environment, modern devices largely forego text-based user interfaces and command-line user interface in favor of graphical user interfaces that utilize icons to represent and enable selectable access to underlying content items. For example, a start or launch screen for a mobile device may be configured to include an arrangement of icons as representations of content items from a file structure of the file system that are managed by the operating system. Some traditional devices, though, provided a fixed arrangement of icons for device applications, which limits users' ability to customize the user interfaces. Additionally, little or no control may be provided to users to change the sizes or behaviors of icons in traditional arrangements. Consequently, users may be unable to adapt the icons to create a user experience that is tailored and intuitive to use.

### SUMMARY

Icon resizing techniques are described herein which enable resizing of icons for a user interface to select between multiple available sizes. The resizing may occur intuitively by using input or gestures applied to an icon to visually move the icon boundaries to a desired size. In one or more implementations, initiation of a resize operation with respect to an icon contained in a user interface is detected. Input received to modify boundaries of the icon may then be tracked and a comparison of the modified boundaries to available sizes supported by the user interface is made. One of the available sizes is selected based on similarity to the modified boundaries and the icon is resized to the selected size. In one approach, resizing is accomplished by a drag and snap operation in which boundaries of an icon are dragged and then released at a desired size, at which point the icon snaps to the closest one of the pre-defined sizes. In addition or alternatively, input patterns (e.g., gestures) associated with pre-defined sizes may be used to select and/or cycle through the different supported sizes.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 illustrates an example operating environment in accordance with one or more implementations.

FIG. 2 is a flow diagram that depicts an example procedure to resize icons in accordance with one or more implementations.

FIG. 3 depict example sizes for icons in accordance with one or more implementations.

FIG. 4 illustrates an example scenario for icon resizing in accordance with one or more implementations.

FIG. 5 is a flow diagram that depicts an example procedure for modification of an arrangement of icons in accordance with one or more implementations.

FIG. 6 illustrates an example scenario for modification of an arrangement of icons responsive to resizing in accordance with one or more implementations.

FIG. 7 illustrates an example system and components that can be configured as any type of system or device to implement aspects of the techniques described herein.

### DETAILED DESCRIPTION

### Overview

Traditional device user interfaces may provide fixed icon sizes and arrangements of icons for device applications, which limits users' ability to customize the user interfaces. Consequently, users may be unable to adapt the icons to create a tailored user experience that is intuitive to use.

Icon resizing techniques are described herein which enable resizing of icons for a user interface to select between multiple available sizes. The resizing may occur intuitively by using input or gestures applied to an icon to visually move the icon boundaries to a desired size. In one or more implementations, initiation of a resize operation with respect to an icon contained in a user interface is detected. Input received to modify boundaries of the icon may then be tracked and a comparison of the modified boundaries to available sizes supported by the user interface is made. One of the available sizes is selected based on similarity to the modified boundaries, and the icon is resized to the selected size. In one approach, resizing is accomplished by a drag and snap operation in which boundaries of an icon are dragged and then released at a desired size, at which point the icon snaps to the closest one of the pre-defined sizes. In addition or alternatively, input patterns (e.g., gestures) associated with pre-defined sizes may be used to select and/or cycle through the different supported sizes.

The icon resizing described herein provides a mechanism by which users are able to customize icon sizes as well as the arrangement of the icons one to another. In conjunction with functionality to choose the applications and other content items for which icons are displayed and/or set the locations of the icons, the icon resizing facilitates creation of a tailored user experience in which items the user considers most important may be presented prominently and easily accessible. As such, user satisfaction with the device may be increased.

In the following discussion, an example environment is first described that may employ the techniques described herein. Example devices, user interfaces, and procedures are then described which may be implemented within the example environment as well as in other environments.

Consequently, implementation of the example devices, user interfaces and procedures is not limited to the example environment and the example environment is not limited to the example devices, user interfaces, and procedures.

Example Environment

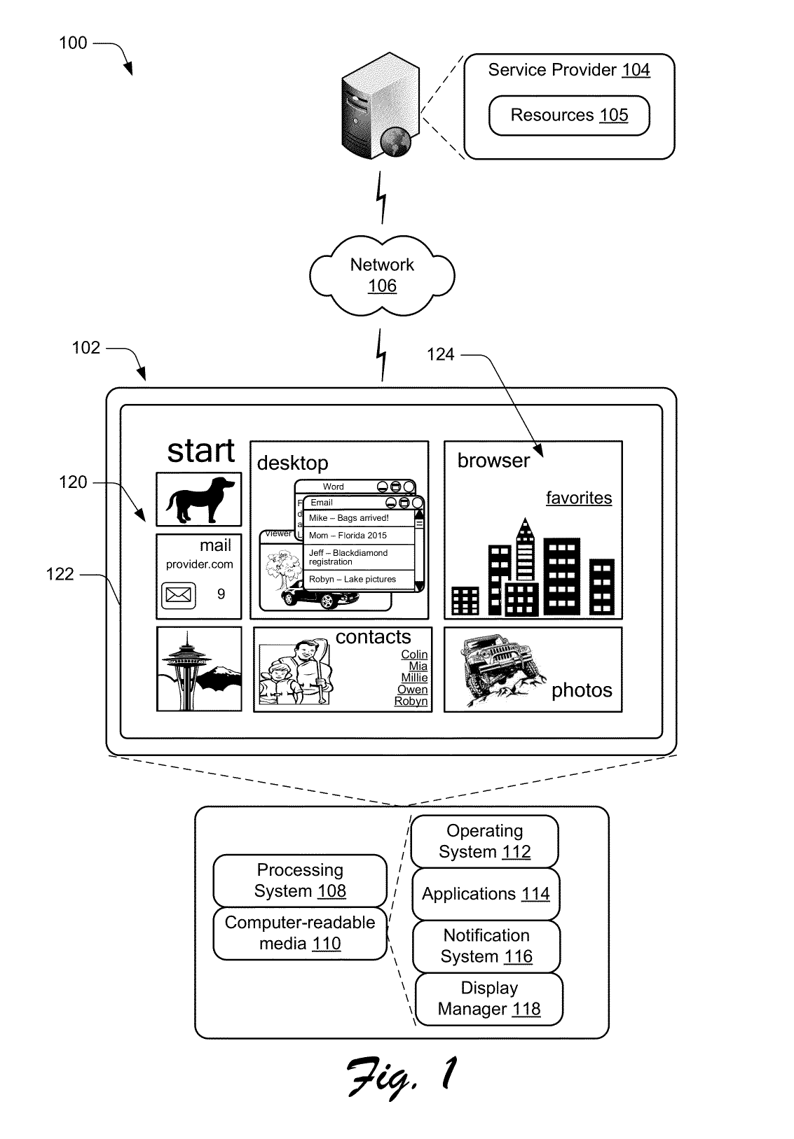

FIG. 1 is an illustration of an environment 100 in an example implementation that is operable to employ techniques described herein. The illustrated environment 100 includes a computing device 102 and a service provider 104 having various resources 105 that are communicatively coupled via a network 106. The computing device may be configured in various ways to access and interact with various resources 105 (e.g., content and services) that are made available by the service provider 104 over the network 106. Resources 105 can include any suitable combination of content and/or services typically made available over a network by one or more service providers. For instance, content can include various combinations of text, video, ads, audio, multi-media streams, animations, images, webpages, and the like. Some examples of services include, but are not limited to, an online computing service (e.g., “cloud” computing), an authentication service, web-based applications, a file storage and collaboration service, a search service, messaging services such as email and/or instant messaging, and a social networking service. The computing device 102 and the service provider 104 may be implemented by a wide range of computing devices.

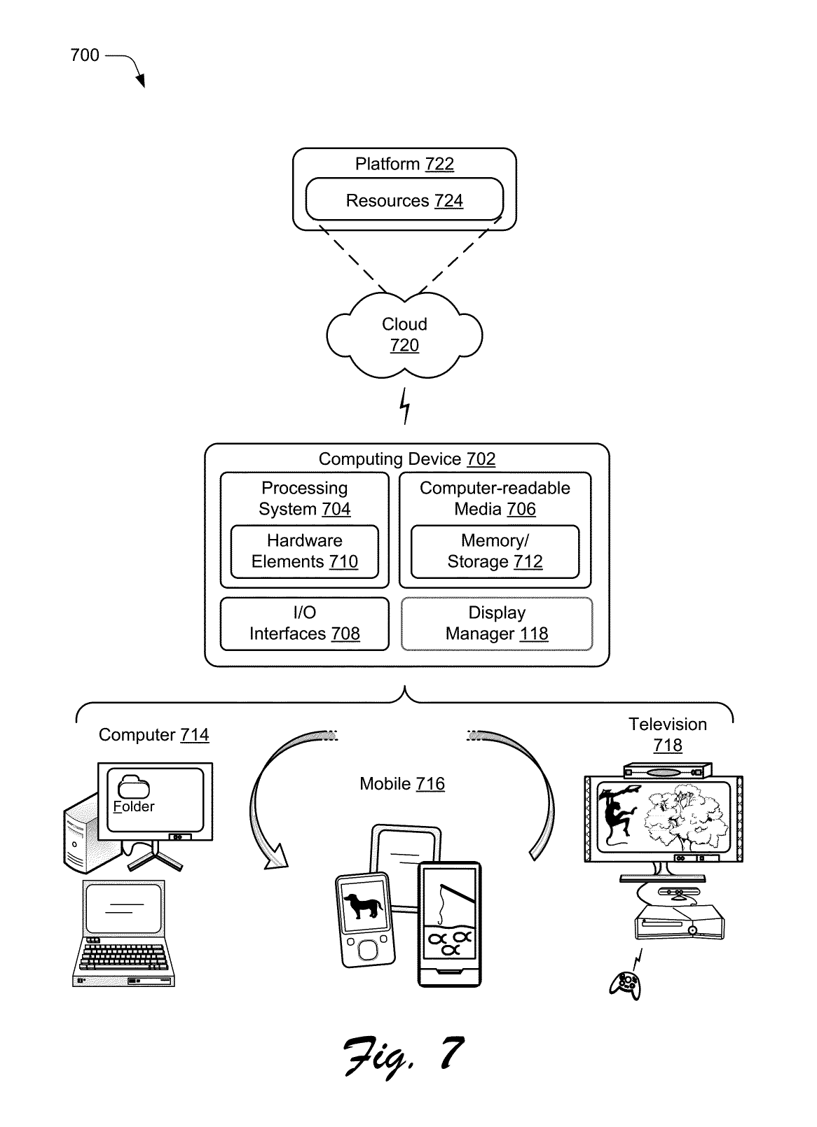

For example, a computing device 102 may be configured as a computer that is capable of communicating over the network 106, such as a desktop computer, a mobile station, an entertainment appliance, a tablet or slate device, a surface computing device, a set-top box communicatively coupled to a display device, a mobile communication device (e.g., a wireless phone as illustrated), a game console, and so forth. The computing device 102 may be configured as any suitable computing system and/or device that employ various processing systems, some additional examples of which are discussed in relation to the example system of FIG. 7.

The computing device 102 is further illustrated as including a processing system 108 and computer-readable media 110 through which various functionality described herein may be implemented. Details and examples of suitable processing systems and computer-readable media are also included below in the discussion of the example system of FIG. 7.

The computer-readable media 110 is depicted as storing example program modules representative of various functionality that may be executed via the processing system 108, including an operating system 112, applications 114, a notification system 116, and a display manager 118 that operate as described herein. Although illustrated in the depicted example as standalone applications, the notification system 116 and display manager 118 may be combined together and/or or with other applications 114, or may alternatively represent components integrated with the operating system 112.

Generally speaking, the operating system 112 is configured to abstract underlying functionality of the computing device 102 to applications 114 that are executable on the computing device 102. For example, the operating system 112 may abstract processing, memory, network, and/or display functionality of the computing device 102 such that the applications 114 may be written without knowing “how” this underlying functionality is implemented. The application 114, for instance, may provide data to the operating system 112 to be rendered and displayed by the display device without understanding how this rendering will be performed. The operating system 112 may provide various services, interfaces, and functionality that applications 114 may invoke to take advantage of system features. A variety of applications 114 to provide a wide range of functionality to the computing device 102 are contemplated including but not limited to a browser, an office productivity application, an email client, a multi-media management program, device management software, and/or networking applications, to name a few examples.

In one or more implementations, the operating system 112 is configured to facilitate interaction between applications 114 and the notification system 116 to obtain, configure, output and otherwise manage notifications that may be exposed via various user interfaces. Additionally, the operating system 112 may represent other functionality, such as to manage a file system and a user interface(s) navigable by a user of the computing device 102. An example of this is illustrated in FIG. 1 by the user interface 120 configured as start screen presented on a display device 122 for the computing device 102. As illustrated, the operating system 112 may provide a start screen or home page UI for the device that includes icons 124 (e.g., graphic representations) of a various applications 114 that may be configured in various ways, such as by using traditional icons image, tiles, textual descriptions, and so forth. When implemented as tiles or other smart representations, the icons 124 may also incorporate live content that is associated with applications 114 including notifications. The start screen may include icons 124 or other representations of selected items from a hierarchical file structure of the file system managed by the operating system 112. The icons may be selectable to launch a corresponding one of applications 114 for execution on the computing device 102. In this way, a user may readily navigate through a file structure and initiate execution of applications of interest.

An arrangement of multiple icons provided by the user interface 120 may be configured as a paginated interface for the operating system 112 of the computing device 102. The paginated interface may provide multiple separate and distinct pages of icons to represent corresponding content items. In another example, an arrangement of multiple icons in the user interface may be configured as a scrollable, tile-based interface that operates as the start screen for the operating system 112 of the computing device 102. In this example, the start screen may include multiple different icons 124 in the form of tiles as illustrated in FIG. 1. The tiles may be configured to present live content associated with underlying application and content items, such as presenting and updating various notifications from the notification system 116 using the tiles, as discussed herein.

The notification system 116 is representative of functionality to manage notifications such as for alerts, messages, updates, and/or other live content that may be displayed as part of the icon of the applications and via various user interfaces 120. The notification system 116 may operate to obtain various notifications on behalf of applications 114 that register with the notification system. Accordingly, the notifications may be handled by the notification system 116 without executing the corresponding applications 114. For example, the notification system 116 may receive notifications 116 from a variety of different sources, such as from software (e.g., other applications executed by the computing device 102), from a service provider 104 via the network 106, and so on.

For instance, the notification system 116 may interact with the service provider 104 to obtain notifications associated with various resources 105 using a push model, a pull model, or other suitable techniques suitable for obtaining notifications. The notification system 116 may then process the notifications and manage how the notifications are displayed as part of the representations and/or within various user interface without executing the applications 114. This approach may be used to improve battery life and performance of the computing device by not running each of the applications to handle the notifications.

The display manager 118 represents various functionality for managing display of the user interface(s) for the computing device 102 and associated icons. The display manager 118 may also be representative of functionality to manage customizations of the arrangement of icons or other representations presented via the user interface. For instance, the display manager 118 may be configured to implement techniques for icon resizing described in this document. This may include performing operations to detect initiation of icon resizing, ascertain an appropriate icon size from among supported sizes based on input received to perform the resize, and cause resizing of the icon to the selected size. Thus, the display manager 118 may impose constraints on the resizing, such as by constraining the size of icons to a set of supported and/or predefined sizes. Additionally, the display manager 118 may facilitate arrangement of icons into groups and rearrangement of the icons and/or groups within a user interface.

Having considered an example operating environment, consider now the following discussion of icon resizing implementation details that includes description of representative example procedures, scenarios, and user interfaces.

Icon Resizing Implementation Details

As introduced above, a display manager 118 associated with a computing device 102 may be configured to obtain, generate, output, and otherwise manage various user interfaces 120 having arrangements of icons related to different applications and device functionality. This may include enabling users to customize the arrangements of icons and resizing of icons to different supported sizes. Details regarding aspects of such icon resizing are described in this section in relation to some example procedures and scenarios. The described procedures and scenarios may be implemented by way of suitably configured devices, such as by a computing device 102 of FIG. 1 that includes or otherwise make use of a notification system 116 and/or display manager 118.

The procedures described in this document may be implemented utilizing the previously described environment, system, devices, and components and in connection with any suitable hardware, software, firmware, or combination thereof. The procedures may be represented as a set of blocks that specify operations performed by one or more entities and are not necessarily limited to the orders shown for performing the operations by the respective blocks.

In general, functionality, features, and concepts described in relation to the examples above may be employed in the context of the example user interfaces and procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, and procedures herein may be used in any suitable combinations and are not limited to the particular combinations represented by the enumerated examples in this description.

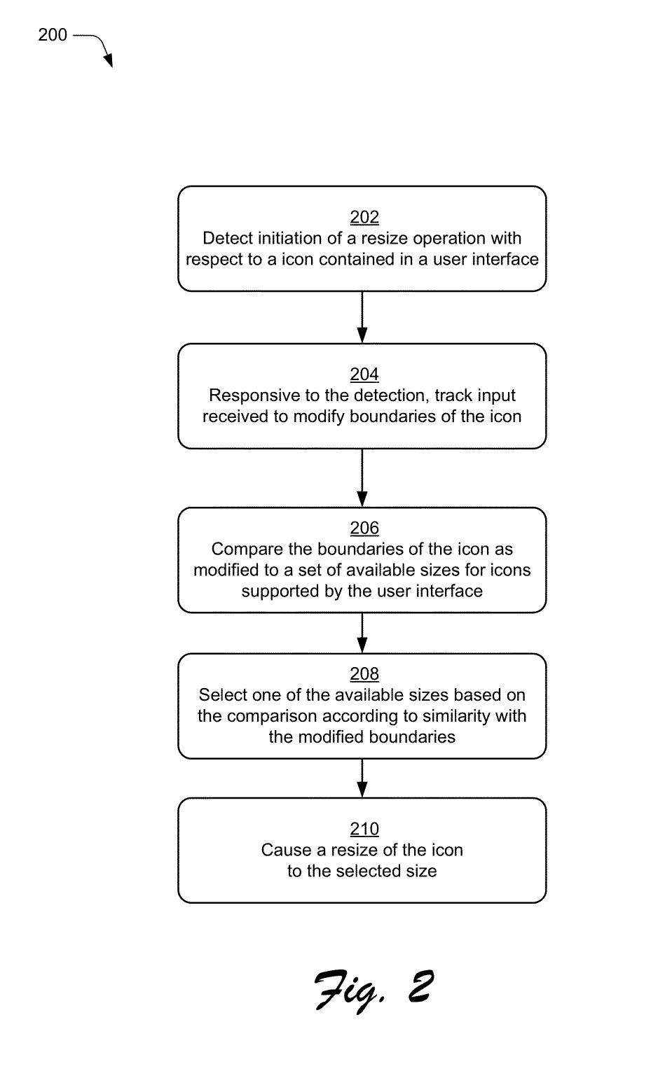

As an example, consider FIG. 2 which illustrates an example procedure 200 to resize icons in accordance with one or more implementations. Initiation of a resize operation with respect to an icon contained in a user interface is detected (block 202). Resize operations can be accomplished in any suitable way such as, by way of example and not limitation, through a touch gesture or input pattern, natural user interface (NUI) gesture, an input device selection, and the like. For example, a user may select an icon the user would like to resize using a defined gesture or action, such as a tap and hold on the icon, a pinch gesture, a keystroke, or a menu selection from a right-click menu using a mouse, to name a few examples. The display manager 118 may be configured to recognize these and other kinds of input to trigger a resize of an icon. In one approach, initiation of a resize operation may cause a resize control or indicator to be exposed in proximity to the selected icon that provides a visual cue that resizing is activated for the icon. The resize control may be configured as an image associated with resizing such as a two-way or four-way arrow, or other indicative image. In another example, the resize control may be configured as a bounding box that surrounds boundaries of the icon, such as a rectangular box. In addition or alternatively, resize indicators, such as small circles or squares, may appear at corners and/or sides of the icon thereby indicating that positions of the corners/sides may be manipulated to resize the icon, by dragging or otherwise. A variety of other examples are also contemplated.

Responsive to the detection, input received to modify boundaries of the icon is tracked (block 204). For example, the display manager 118 may be configured to monitor user input during resize operations in order to ascertain how and when to resize the icon. To do so, the display manager 118 may interact with the operating system 112 to track cursor events, touch input, keyboard input, gesture recognition events, and the like. The input that is tracked is indicative of a size to which the user would like to resize the icon.

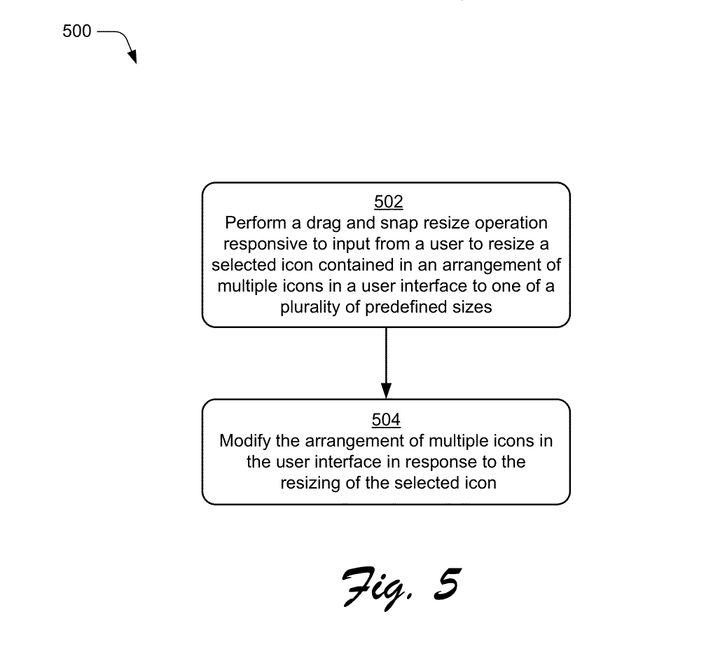

As mentioned, resizing may be accomplished by a drag and snap operation in which boundaries of an icon are dragged and then released at a desired size, at which point the icon snaps to the closest one of the pre-defined sizes. Accordingly, display manager 118 may recognize input to drag the boundaries and determine when the input concludes. For example, a user may modify the boundaries by dragging corners or edges of a bounding box or manipulating resize indicators as mentioned above. Responsive to a determination by the display manager 118 of when input to modify the boundaries concludes, further operations as discussed below may be performed to cause resizing of the icon. A detailed example scenario that includes further details regarding drag and snap operations for icon resizing is discussed below in relation to FIG. 5.

In addition or alternatively, input patterns (e.g., gestures) associated with pre-defined sizes may be used to select and/or cycle through the different supported sizes. The display manager may be configured to define and/or associate various input patterns with corresponding pre-defined icon size using a table, database, or other suitable data structure. For example, swipe gestures in different directions may be employed to bump the boundaries in, out, up, and/or down to set a desired size. For example, swiping to the right may create wider boundaries for an icon and swiping down may create taller boundaries. Likewise, swiping left may create narrower boundaries for an icon and swiping up may create shorter boundaries. A diagonal swipe across the icon from top to bottom may simultaneously create wider and taller boundaries, whereas a diagonal swipe across the icon from bottom to top may simultaneously create narrower and shorter boundaries. The display manager 118 may be configured to recognize these and other input patterns and initiate corresponding action to resize an icon to which the input patterns are applied (e.g., when resizing is activated).

In addition to using drag and snap operations and input patterns, resizing may also be triggered in other ways. For example, a snap to one of the supported sizes can be triggered solely by tracking of the boundaries, and/or by an explicit releasing or conclusion of input as the bounds change. Additionally, an idle timer or other size parameter may be employed to determine when to perform further operations to cause the resize to the nearest supported size. This may occur at the conclusion of input as well as during continued input to modify boundaries and tracking of the changes.

Based on tracking of input as noted above, the boundaries of the icon as modified are compared to a set of available sizes for icons supported by the user interface (block 206) and one of the available sizes is selected based on the comparison according to similarity with the modified boundaries (block 208). Then, a resize of the icon to the selected size is caused (block 210). For example, the display manager 118 may operate to determine an appropriate size for the icon based on the input that is tracked per block 204. The size for icons may be constrained to one of a set of pre-defined sizes. Thus, the icons may be “forced” into one of the predefined sizes, which creates a uniform looking user interface and produces consistency that can be relied upon to perform rearrangements of icons and groups. In general, the display manager 118 operates to match the input that is received to one of a plurality of available sizes for icons supported by the user interface. The icon is then resized to an available size that most closely matches the received input.

To select an appropriate size, a comparison may be made via the display manager 118 to assess similarity of the modified boundaries with the set of available sizes based on one or more dimensions of the modified boundaries, such as the width, height, area, a diagonal, or aspect ratio of the modified boundaries. In one particular example, the dimensions used for the assessment include at least a diagonal of a bounding box for the modified boundaries. Based on the comparison, one of the available sizes that has a shape and size that are similar to the modified boundaries may be identified. Then, the icon is resized to the size that is identified. Here, the modified boundaries used in the comparison may be formed by a drag operation or by using input patterns as noted above, or through other suitable types of input.

Various animations and cues may also be employed as part of resize operations described above and below. By way of example and not limitation, representations to indicate boundaries associated with one or more of the available sizes may be output in connection with the tracking. Additionally, a preview depiction of the icon growing or shrinking in size may be rendered as input is being received to resize the icon. Thus, as a user is engaged in resizing an icon, an animation may show changes in the boundaries of the icon. When the modified boundaries approach different available sizes, a border, shadow, or other indication representing the size of the nearest available pre-defined size may be exposed within the user interface to provide visual feedback. In one approach, indicators for multiple different pre-defined sizes may be exposed in succession as input to modify the boundaries continues through a range of dimensions. Additionally, the icon may snap to each size in succession as a user continues to modify boundaries.

Additionally, a transition animation to represent the resizing of the icon may be provided when conclusion of input to modify the size is detected. A variety of transition animations are contemplated. For example, an icon may be rendered to take the dimensions of the boundaries as modified and then be represented as snapping to the selected size. Optionally, a translucent or see-through image of the icon may be used for the transition animation. Thus, if the modified boundaries overlap the selected size, the icon may appear to shrink back to the selected size. On the other hand, if the modified boundaries are somewhat smaller than the selected size, the icon may appear to grow out to the selected size. In another example, visual transition effects may be applied to represent the resizing such as fading in/out, peeling away, blind effects, boxing in/out, and other suitable visual transition effects.

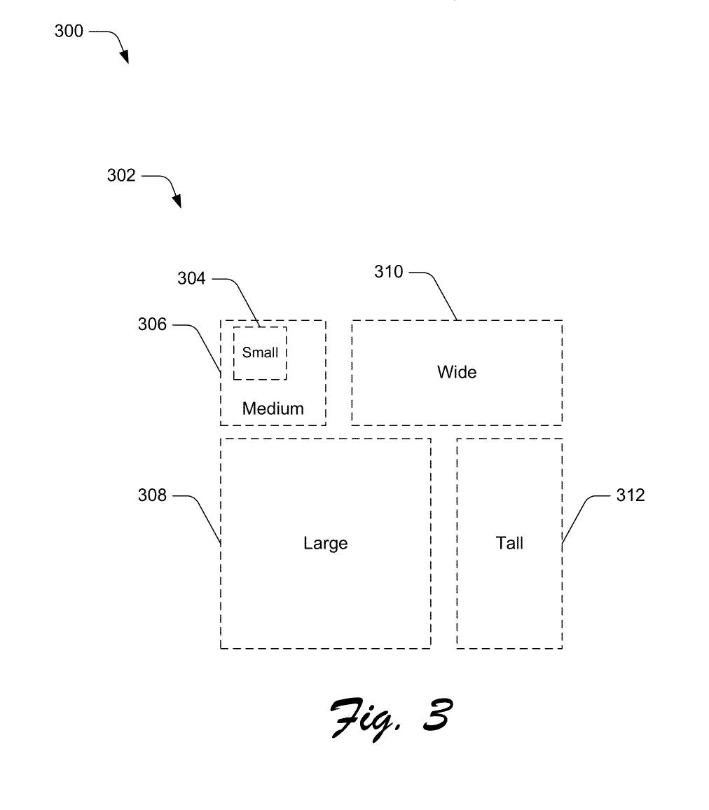

As an example of pre-defined sizes, FIG. 3 depicts generally at 300 an example representation of different sizes for icons that may be supported by a device/user interface in accordance with one or more implementations. In this example, a size matrix 302 represents different, relative sizes that may be utilized in one or more implementation. In particular, the set of available sizes in the example of FIG. 3 includes small 304, medium 306, large 308, wide 310, and tall 312 sizes relative to one another. Thus, in this example up to five pre-defined sizes for icons may be available. Naturally, the number and particular sizes are not limited to the representative examples in FIG. 3, and it is contemplated that more or less than five pre-defined sizes may be employed, and also that the relative dimensions and even the shapes (e.g., irregular shapes, oval, circular, and other geometric shapes) of the pre-defined sizes may vary in different implementations. Additionally, shapes made available may vary in different context. For example, a list of shapes for a particular context may include all the supported shapes of a subset of sizes selected for the particular context. For instance, a filtered, context-specific list of supported sizes may be obtained based on criteria including but not limited to sizes supported by the item, type of item, application constraints, device capabilities, user preference settings, display device capabilities, and so forth.

The modification of the boundaries may be constrained within a size range corresponding the set of available sizes. For example, modification may be prevented from moving boundaries to dimensions smaller than the smallest supported size or larger than the largest available size. The example sizes as well as other configurations of a size matrix 302 may be employed in the context of the preceding environment of FIG. 1 and procedure 200 of FIG. 2, as well as in the context of the following example procedures and scenarios.

It just so happens that in the example of FIG. 3, five pre-defined sizes that are substantially rectangular are utilized. The small 304, medium 306, large 308 sizes are represented as squares with the small size being approximately half the length and width of the medium size, and the medium size being approximately half the length and width of the large size. Thus, four small icons may fit in the same space as one medium icon, and four medium icons may fit in the same space as one large icon. Similarly, the wide size 310 is a rectangle having two times the width of the medium size with the same height and the tall size 312 is a rectangle having two times the height of the medium size with the same width.

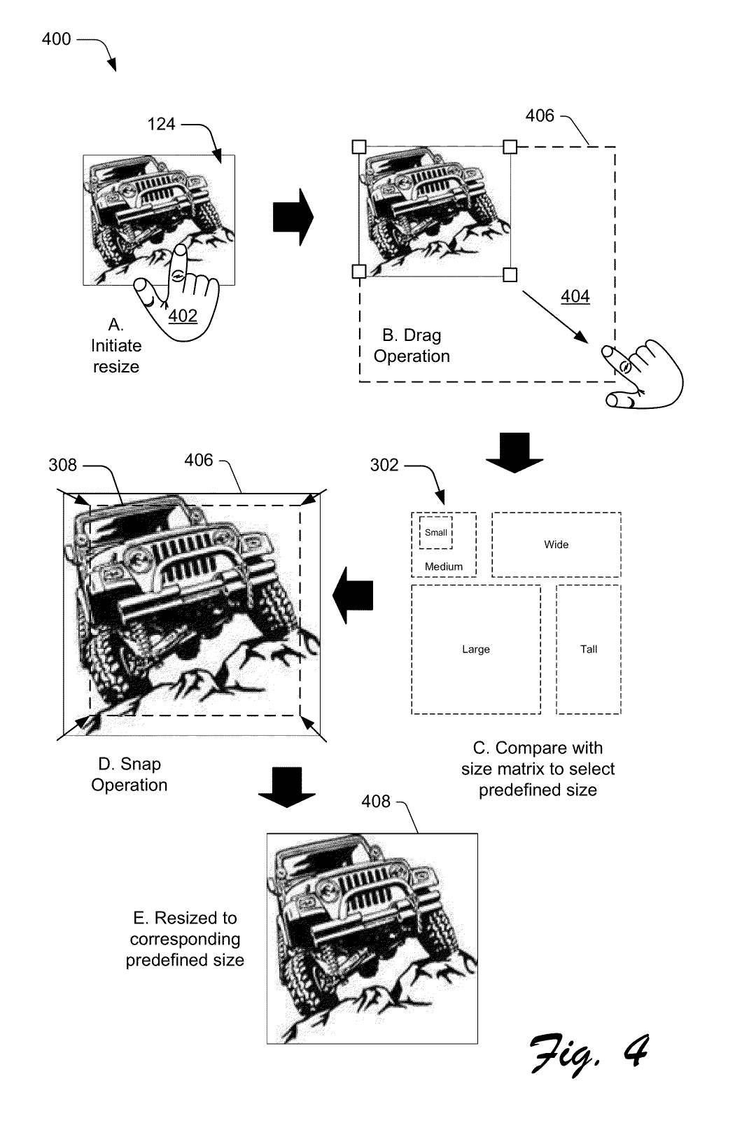

FIG. 4 depicts generally at 400 an example scenario for icon resizing in accordance with one or more implementations. In particular, the depicted example represents details related to icon resizing using drag and snap operations. Representative operations that may be involved in resizing are represented using letters “A” to “E”. At A, operations to perform a resize are initiated. For example, a user may interact with an icon 124 to activate a resize mode with respect to the icon, such as by a press and hold gesture 402 applied to the “Jeep” icon as shown in FIG. 4. Other types of input to initiate resizing of the icon are also contemplated, examples of which were previously described. With the resize mode activated, a user may take action to modify boundaries of the icon or otherwise resize the icon using various techniques described above and below.

At B for instance, a representation of a drag operation 404 is illustrated. The drag operation 404 may involve dragging of manipulable corners of the icon 124 that are exposed in the resize mode. For example, dragging of the bottom left corner through touch input is depicted in FIG. 4. Here, the dragging causes a change in the dimensions of a bounding box 406 associated with the icon. Naturally, other techniques may also be used, such as using input patterns/gestures mentioned above to cause the boundaries to change and/or cycle through available size options. Here, though, the drag operation 404 drags a corner diagonally to create a bounding box 406 that is larger (e.g., wider and taller) than the dimensions of the icon 124. At this point, the user may conclude the input and the display manager 118 or other comparable functionality may recognize the conclusion of the input, as well as the modified dimensions.

Then at C, the bounding box 406 that is created may be compared to a size matrix that defines pre-defined icons sizes that are supported by the system. For example, the bounding box 406 may be compared to the sizes in the example size matrix 302 of FIG. 3 or another suitable set of available sizes to select a predefined size. The comparison is configured to identify a size option that is most similar to the dimensions of the bounding box 406. This may be based on an assessment of similarity between one or more dimensions of the bounding box 406 and each predefined size to ascertain a closest match. The size that is determined to be the closest match is then selected for the resizing.

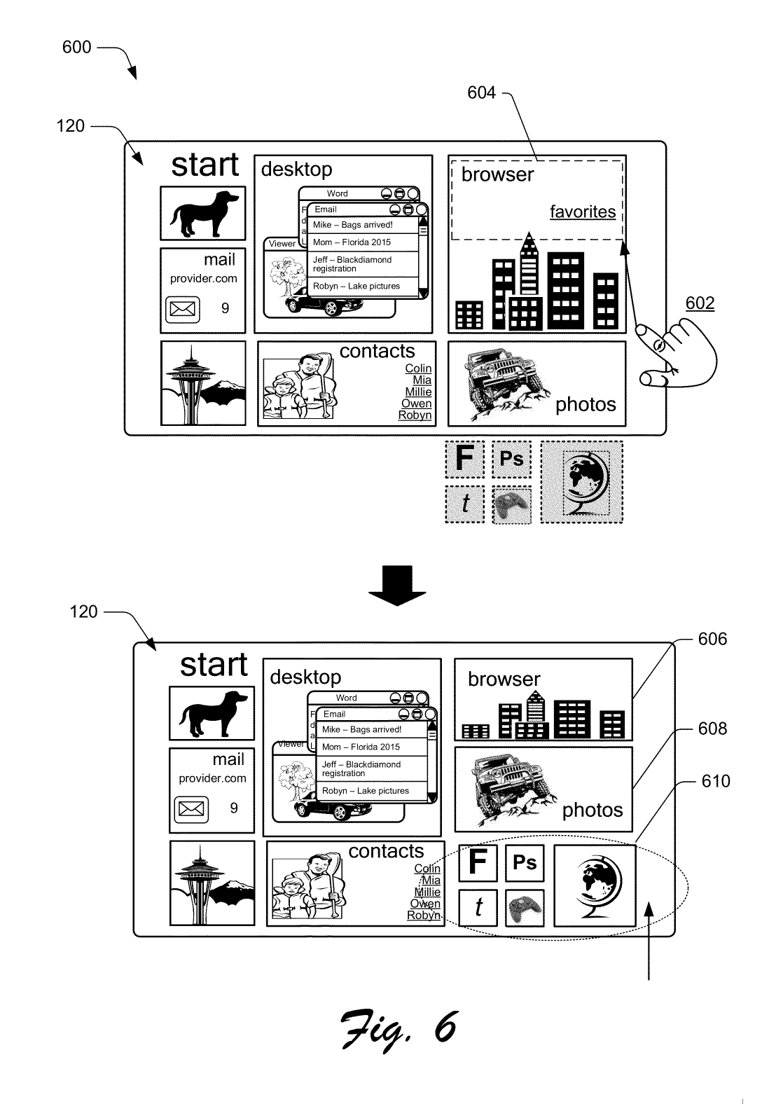

Having selected one of the predefined sizes, a snap operation is performed at D to cause resizing of the icon to the selected size. In this example, the large 308 size may be selected according to the comparison. As represented in FIG. 4, the dimensions of bounding box 406 box are slightly larger than the large 308 size. Accordingly, the snap operation at D may involve shrinking the bounding box 406 and/or icon down to the large size. Naturally, the reverse may be the true (e.g., selected size is larger than bounding box) in which case the snap operation at D may involve expanding the bounding box 406 and/or icon up to the large size. At E, a representation 408 of the icon 124 resized to the corresponding predefined size is depicted. The representation 408 may be exposed within various user interfaces 120 as described previously. In at least some cases, resizing of the icon may cause a modification of an arrangement of a plurality of icons in a user interface 120, details and examples of which are discussed just below in relation to FIGS. 5 and 6.

In particular, FIG. 5 depicts a flow diagram that depicts an example procedure 500 for modification of an arrangement of icons in accordance with one or more implementations. A drag and snap resize operation is performed responsive to input from a user to resize a selected icon contained in an arrangement of multiple icons in a user interface to one of a plurality of predefined sizes (block 502). For example, a display manager 118 may be implemented to perform a drag and snap resize operation in the manner previously described. This may be accomplished using any of the operations and techniques discussed in relation to the example environment, procedures, representations, and scenarios of FIGS. 1 to 4.

The arrangement of multiple icons in the user interface is modified in response to the resizing of the selected icon (block 504). A variety of modifications of an arrangement of multiple icons are contemplated. For example, the resizing of an icon may create a change in the amount of display screen real estate that is available within a viewing pane for the user interface. As such, additional content items may be represented with corresponding icons when additional space is created by icon resizing. On the other hand, some icons may be moved outside of the viewable area defined by the viewing pane when resizing results in less available space. Moreover, the resized icon may be relocated within the arrangement of multiple icons and the alignment/positions of icons one to another may also be modified in response to the resizing.

As an example, consider FIG. 6, which illustrates generally at 600 an example scenario for modification of an arrangement of icons responsive to resizing in accordance with one or more implementations. Here, a user interface 120 as discussed in relation to FIG. 1 and elsewhere herein is depicted at the top of the page. The user interface 120 may be a scrollable, tiled-based interface (as illustrated) or another interface that provides an arrangement of multiple icons. In the illustrated example, input 602 to trigger resize of an icon (e.g., tile) that corresponds to a browser application is represented. In particular, the input 602 may be configured as an upward drag of boundaries of the icon, a swipe gesture applied to the icon, or other suitable input, input pattern, or gesture to initiate resize of the icon. In this particular example, the input 602 is configured to create a bounding box 604 that may correspond to a transition from a large 308 size for the tile to a wide 310 size for the icon.

Thereafter, a transition occurs in which the icon is resized accordingly to create a resized icon 606 as shown in the bottom of FIG. 6. The resizing of the icon may cause various modifications of the arrangement of icons in the user interface to occur. For example, modifying the arrangement of multiple icons may include relocating one or more of the multiple icons relative to one another to accommodate the resized icon. This is represented by movement of the example “photos” icon 608 up to fill the space previously occupied by the resized icon 606. Additionally, modification of the arrangement of multiple icons may include exposing one or more additional icons in a display of the user interface to fill additional space created by resizing of the icon. This is represented by additional icons 610 that have been added to the user interface 120 at the bottom of the page to take-up space produced by the resize. The additional icons 610 may have been previously located outside of the viewable area of a viewing pane for the user interface 120. Of course, the reverse is true when icons are expanded to larger sizes, in which case some icons may be pushed or otherwise relocated outside of the viewable area within the viewing pane in response to the resizing. Various other modifications and rearrangements of icon are also contemplated.

Having considered example implementation details, consider now the following discussion of an example system which may be employed in one or more implementations to provide icon resizing described herein.

Example System

FIG. 7 illustrates an example system 700 that includes an example computing device 702 that is representative of one or more computing systems and/or devices that may implement the various techniques described herein. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 706 is illustrated as including memory/storage 712. The memory/storage 712 represents memory/storage capacity associated with one or more computer-readable media. The memory/storage 712 may include volatile media (such as random access memory (RAM)) and/or nonvolatile media (such as read only memory (ROM), Flash memory, optical disks, magnetic disks, and so forth). The memory/storage 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone for voice operations, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “communication media.”

“Computer-readable storage media” refers to media and/or devices that enable storage of information in contrast to mere signal transmission, carrier waves, or signals per se. Thus, computer-readable storage media does not include signal bearing media, transitory signals, or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Communication media” may refer to signal-bearing media that is configured to transmit instructions to the hardware of the computing device 702, such as via a network. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules including the operating system 112, applications 114, notification system 116, display manager 118 and other program modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of modules as a module that is executable by the computing device 702 as software may be achieved at least partially in hardware, e.g., through use of computer-readable storage media and/or hardware elements 710 of the processing system. The instructions and/or functions may be executable/operable by one or more articles of manufacture (for example, one or more computing devices 702 and/or processing systems 704) to implement techniques, modules, and examples described herein.

As further illustrated in FIG. 7, the example system 700 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 700, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 702 may assume a variety of different configurations, such as for computer 714, mobile 716, and television 718 uses. Each of these configurations includes devices that may have generally different constructs and capabilities, and thus the computing device 702 may be configured according to one or more of the different device classes. For instance, the computing device 702 may be implemented as the computer 714 class of a device that includes a personal computer, desktop computer, a multi-screen computer, laptop computer, netbook, and so on.

The computing device 702 may also be implemented as the mobile 716 class of device that includes mobile devices, such as a mobile phone, portable music player, portable gaming device, a tablet computer, a multi-screen computer, and so on. The computing device 702 may also be implemented as the television 718 class of device that includes devices having or connected to generally larger screens in casual viewing environments. These devices include televisions, set-top boxes, gaming consoles, and so on.

The techniques described herein may be supported by these various configurations of the computing device 702 and are not limited to the specific examples of the techniques described herein. This is illustrated through inclusion of the notification system 116 on the computing device 702. The functionality represented by the notification system 116 and other modules/applications may also be implemented all or in part through use of a distributed system, such as over a “cloud” 720 via a platform 722 as described below.

The cloud 720 includes and/or is representative of a platform 722 for resources 724. The platform 722 abstracts underlying functionality of hardware (e.g., servers) and software resources of the cloud 720. The resources 724 may include applications and/or data that can be utilized while computer processing is executed on servers that are remote from the computing device 702. Resources 724 can also include services provided over the Internet and/or through a subscriber network, such as a cellular or Wi-Fi network.

The platform 722 may abstract resources and functions to connect the computing device 702 with other computing devices. The platform 722 may also serve to abstract scaling of resources to provide a corresponding level of scale to encountered demand for the resources 724 that are implemented via the platform 722. Accordingly, in an interconnected device embodiment, implementation of functionality described herein may be distributed throughout the system 700. For example, the functionality may be implemented in part on the computing device 702 as well as via the platform 722 that abstracts the functionality of the cloud 720.

### CONCLUSION

Although techniques and aspects have been described in language specific to structural features and/or methodological acts, it is to be understood that the subject matter defined in the appended claims are not necessarily limited to the specific features or acts described. Rather, the specific features and acts are disclosed as example forms of implementing the claimed subject matter.

What is claimed is:

1. A method implemented by a computing device comprising:
detecting initiation of a resize operation with respect to an icon contained in a user interface;
responsive to the detection, tracking input received to modify boundaries of the icon;
comparing the boundaries of the icon as modified to a set of available sizes for icons supported by the user interface;
selecting one of the available sizes for the icons based on the comparison according to similarity with the modified boundaries; and
causing a resize of the icon to the selected size.

2. The computer-implemented method of claim 1, wherein the comparing comprises assessing similarity of the modified boundaries with the set of available sizes based on one or more dimensions of the modified boundaries.

3. The computer-implemented method of claim 2, wherein the one or more dimensions include a diagonal of a bounding box for the modified boundaries.

4. The computer-implemented method of claim 1, wherein the input received to modify boundaries of the icon comprises a drag operation performed upon the icon.

5. The computer-implemented method of claim 4, further comprising:
determining when the drag operation concludes; and
performing the comparing, selecting, and causing to resize the icon responsive to conclusion of the drag operation.

6. The computer-implemented method of claim 1, wherein causing the resize of the icon includes rendering an animation to represent snapping of the icon from the modified boundaries to the selected size.

7. The computer-implemented method of claim 1, wherein the input received to modify boundaries of the icon comprises input to cycle through the set of available sizes.

8. The method of claim 1, wherein the set of available sizes includes small, medium, large, wide, and tall sizes relative to one another.

9. The computer-implemented method of claim 1, further comprising outputting representations to indicate boundaries associated with one or more of the available sizes in connection with the tracking.

10. The computer-implemented method of claim 1, wherein the icon comprises a representation of an application within an arrangement of multiple icons that each represent corresponding content items and are selectable to initiate interaction with corresponding content items.

11. The computer-implemented method of claim 1, further comprising modifying the arrangement of multiple icons in the user interface responsive to resizing of the icon.

12. The computer-implemented method of claim 1, further comprising constraining modification of the boundaries within a size range corresponding to the set of available sizes.

13. A computing device comprising:
a processing system;
one or more computer readable storage media storing instructions which, when executed by the processing system, perform operations comprising:
tracking input received to modify a size of an icon included in an arrangement of multiple icons in a user interface that each represent underlying content items;
matching the input that is received to one of a plurality of available sizes for icons supported by the user interface; and
resizing the icon to said one of the plurality of available sizes that matches the received input.

14. The computing device of claim 13, wherein the matching comprises selecting one of the available sizes for the icons based on similarity of the sizes with modified boundaries produced by the input received to modify the size.

15. The computing device of claim 13, wherein the matching comprises:
associating input patterns with each of the plurality of available sizes;
recognizing one of the input patterns based on tracking of the input; and
selecting the one of the plurality of available sizes that is associated with the recognized input pattern.

16. The computing device of claim 13, wherein the arrangement of multiple icons in the user interface comprises a paginated interface for an operating system of the computing device.

17. The computing device of claim 13, wherein the arrangement of multiple icons in the user interface comprises a scrollable, tile-based interface configured as a start screen for an operating system of the computing device.

18. One or more computer readable storage media storing computer-readable instructions which, when executed by a processing system, implement a display manager configured to perform operations comprising:
performing a drag and snap resize operation responsive to input from a user to resize a selected icon contained in an arrangement of multiple icons in a user interface to one of a plurality of predefined sizes; and
modifying the arrangement of multiple icons in the user interface in response to resizing of the selected icon.

19. The one or more computer readable storage media of claim 18, wherein modifying the arrangement of multiple icons comprises relocating one or more of the multiple icons relative to one another to accommodate the resized icon.

20. The one or more computer readable storage media of claim 18, wherein modifying the arrangement of multiple icons comprises exposing one or more additional icons in a display of the user interface to fill additional space created by resizing of the icon.
